(19) United States
(12) Patent Application Publication
(10) Pub. No.: US 2026/0108994 A1
(43) Pub. Date: Apr. 23, 2026

(54) JIG ASSEMBLY FOR FIXING SUBSTRATE AND FIXING METHOD USING THE SAME

(71) Applicants: HYUNDAI MOTOR COMPANY, SEOUL (KR); KIA CORPORATION, SEOUL (KR)

(72) Inventors: Min Je Park, Hwaseong-si (KR); Ji Hoon Cha, Hwaseong-si (KR)

(73) Assignees: HYUNDAI MOTOR COMPANY, SEOUL (KR); KIA CORPORATION, SEOUL (KR)

(21) Appl. No.: 19/225,803

(22) Filed: Jun. 2, 2025

(30) Foreign Application Priority Data
Oct. 18, 2024 (KR) 10-2024-0143305
Dec. 26, 2024 (KR) 10-2024-0197676

(51) Int. Cl. B23Q 3/06; B23Q 3/08

(52) U.S. Cl. CPC B23Q 3/062; B23Q 3/088; B23Q 2703/04

(57) ABSTRACT

A substrate fixing jig assembly includes a carrier having a substrate fixing jig insertion recess, a substrate fixing jig removably inserted into the substrate fixing jig insertion recess and having a substrate accommodating portion, and a substrate support portion slidably provided on the substrate fixing jig and fixing a substrate accommodated in the substrate accommodating portion.

### CROSS REFERENCE TO RELATED APPLICATIONS

This application claims benefit of priority to Korean Patent Application Nos. 10-2024-0143305 filed on Oct. 18, 2024 and 10-2024-0197676 filed on Dec. 26, 2024, in the Korean Intellectual Property Office, the disclosures of which are incorporated herein by reference in their entirety.

### BACKGROUND

### 1. Field

The present disclosure relates to a substrate fixing jig and a substrate fixing method using the same.

### 2. Description of Related Art

A sintering process, a process of heating powder or film-shaped materials at high temperature to be bound into a solid, has been widely used in the manufacturing of electronic devices, semiconductor packages, and power modules. For example, metal powder, ceramic, or composite materials may be sintered on a surface of a circuit board (PCB, ceramic substrate, etc.) to form an electrical connection portion of an electronic component.

The sintering process has been used as a method for mounting an electronic component on a substrate. In order to perform the sintering process, a pre-bonding process is performed before the sintering process to pre-bond the electronic component to a substrate. In this pre-bonding process and the sintering process, a substrate fixing jig is used to fix the substrate. The substrate fixing jig plays a role in fixing the substrate while the sintering process is performed. The substrate fixing jig may support the substrate in a designated position during the pre-bonding process and the sintering process.

### SUMMARY

An aspect of the present disclosure is to provide a substrate fixing jig assembly capable of minimizing bending deformation of a substrate and a substrate fixing method using the same.

Another aspect of the present disclosure is to provide a substrate fixing jig assembly capable of maintaining a substrate in a correct position during a sintering process and a substrate fixing method using the same.

According to an aspect of the present disclosure, a substrate fixing jig assembly includes a carrier having a substrate fixing jig insertion recess, a substrate fixing jig removably inserted into the substrate fixing jig insertion recess and having a substrate accommodating portion, and a substrate support portion slidably provided on the substrate fixing jig and fixing a substrate accommodated in the substrate accommodating portion.

According to another aspect of the present disclosure, a substrate fixing method includes a substrate fixing jig coupling operation of coupling a substrate fixing jig to an opening/closing module, a substrate mounting operation of slidingly moving a substrate support portion of the substrate fixing jig and then mounting a substrate in a substrate accommodating portion provided on one surface of the substrate fixing jig, a substrate fixing operation of slidably moving the substrate support portion to fix the substrate to the substrate fixing jig, a substrate fixing jig separating operation of separating the substrate fixing jig from the opening/closing module; a substrate fixing jig mounting operation of mounting the substrate fixing jig in a substrate fixing jig insertion recess of a carrier, and a substrate fixing jig pressing operation of pressing a side surface of the substrate fixing jig with a jig fixing unit provided on the carrier to fix the substrate fixing jig to the carrier.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a schematic perspective view of a substrate fixing jig assembly according to an embodiment of the present disclosure;

FIG. 2 is a schematic exploded top perspective view of a substrate fixing jig assembly according to an embodiment of the present disclosure;

FIG. 3 is a schematic exploded bottom perspective view of a substrate fixing jig assembly according to an embodiment of the present disclosure;

FIG. 4 is a cross-sectional view taken along line I-I′ of FIG. 1;

FIG. 5 is a schematic plan view of a carrier according to an embodiment of the present disclosure;

FIG. 6 is a cross-sectional view taken along line II-II′ of FIG. 5;

FIG. 7 is a cross-sectional view taken along line III-III′ of FIG. 5;

FIG. 8 is a schematic exploded top perspective view of a substrate fixing jig and a substrate support portion according to an embodiment of the present disclosure;

FIG. 9 is a schematic exploded bottom perspective view of a substrate fixing jig and a substrate support portion according to an embodiment of the present disclosure;

FIG. 10 is a cross-sectional view taken along line IV-IV′ of FIG. 1;

FIG. 11 is a plan view illustrating a state in which a substrate support portion is slidably moved in a substrate fixing jig so that a substrate may be coupled and separated;

FIG. 12 is a plan view illustrating a state in which a substrate is fixed in a substrate fixing jig;

FIG. 13 is a cross-sectional view illustrating an operation of a substrate support portion according to an embodiment of the present disclosure; and

FIG. 14 is a schematic flowchart of a substrate fixing method according to another embodiment of the present disclosure.

### DETAILED DESCRIPTION

While the present disclosure may be modified in various manners and may take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit, part, portion, etc.” may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the description below, terms “up/down,” “left/right,” “above,” “upper portion,” “below,” “lower portion,” etc. used in relation to directions are described based on the illustration in the drawing.

Embodiments of the present disclosure are described in detail with reference to the accompanying drawings.

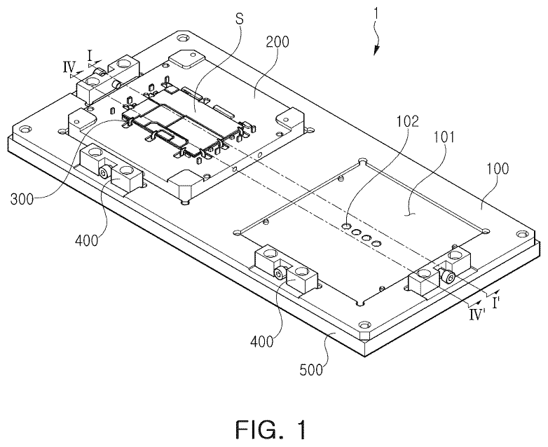

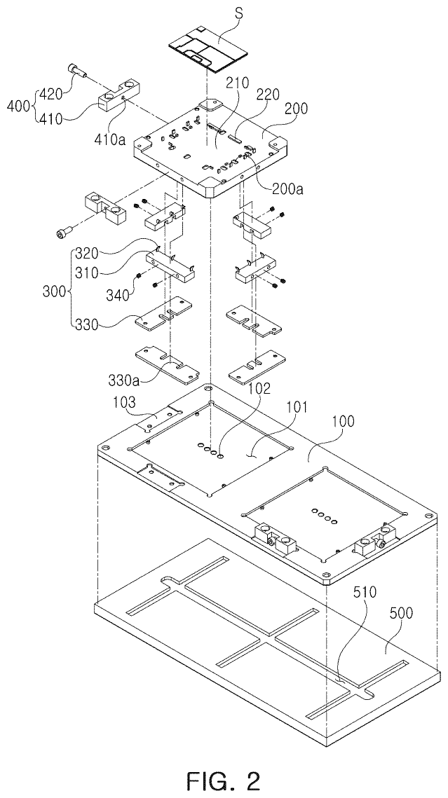

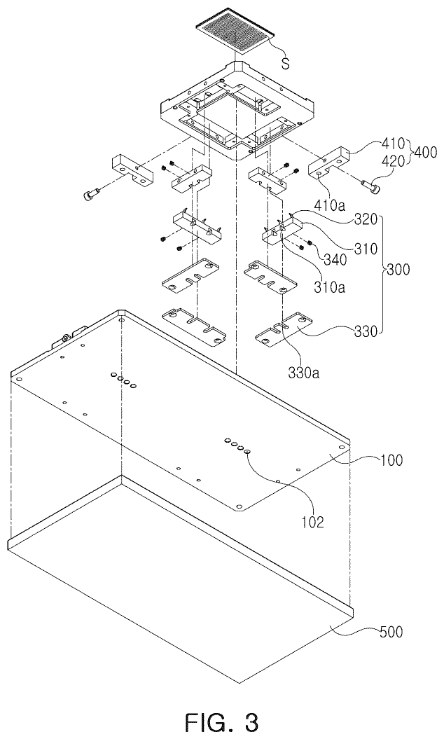

FIG. 1 is a schematic perspective view of a substrate fixing jig assembly according to an embodiment of the present disclosure, FIG. 2 is a schematic exploded perspective view of a substrate fixing jig assembly according to an embodiment of the present disclosure, and FIG. 3 is a schematic exploded perspective view of a substrate fixing jig assembly according to an embodiment of the present disclosure viewed at an angle different from that of FIG. 2.

Referring to FIGS. 1 to 3, a substrate fixing jig assembly 1 according to an embodiment of the present disclosure may fix a substrate S when various processes, such as a sintering process for mounting electronic components, an SMT process, etc. are performed on the substrate. The substrate fixing jig assembly 1 may include, for example, a carrier 100, a substrate fixing jig 200, and a substrate support portion 300.

The carrier 100 may fix and transport the substrate fixing jig 200. A substrate fixing jig 200 may be detachably coupled to the carrier 100. The carrier 100 may transfer heat generated by a heat plate 500 to the substrate fixing jig 200. The heat of the heat plate 500 may be transferred to the substrate fixing jig 200 through the carrier 100. The carrier 100 may be formed of, for example, a metal material. The carrier 100 may include a substrate fixing jig insertion recess 101 into which the substrate fixing jig 200 is inserted. The carrier 100 may be provided with a jig fixing unit 400 pressing and fixing an outer surface of the substrate fixing jig 200 when the substrate fixing jig 200 is inserted into the substrate fixing jig insertion recess 101. The jig fixing unit 400 may include a plurality of jig fixing units. When the plurality of jig fixing units 400 are provided, the plurality of jig fixing units 400 may press the substrate fixing jig 200 in opposite directions.

The substrate S may be fixed on the substrate fixing jig 200. The substrate S may be removably fixed on one surface of the substrate fixing jig 200. A substrate accommodating portion 210 may be provided on one surface of the substrate fixing jig 200. The substrate S may be mounted on the substrate accommodating portion 210. The substrate accommodating portion 210 may refer to a portion of one surface of the substrate fixing jig 200. For example, the substrate accommodating portion 210 may be a central region of an upper surface of the substrate fixing jig 200. However, it is also possible for the substrate accommodating portion 210 to have a recess shape. In other words, the substrate accommodating portion 210 may be depressed from one surface of the substrate fixing jig 200 by a predetermined depth to be provided. The substrate support portion 300 may be provided along the edge of the substrate accommodating portion 210.

The substrate support portion 300 may fix the substrate S when the substrate is mounted on the substrate accommodating portion 210. The substrate support portion 300 may be provided along the edge of the substrate accommodating portion 210. The substrate support portion 300 may be provided in plural. The substrate support portion 300 may be provided to be slidably moved on the substrate fixing jig 200. Depending on the position of the substrate support portion 300, the substrate S may be fixed to the substrate accommodating portion 210 or may be separated from the substrate accommodating portion 210.

A heat plate 500 may be provided to heat the substrate S. The heat plate 500 may be connected to a bottom surface of the carrier 100. The heat plate 500 may generate heat upon receiving power from an external power source. The heat generated by the heat plate 500 may be transferred to the substrate S through the carrier 100 and the substrate fixing jig 200.

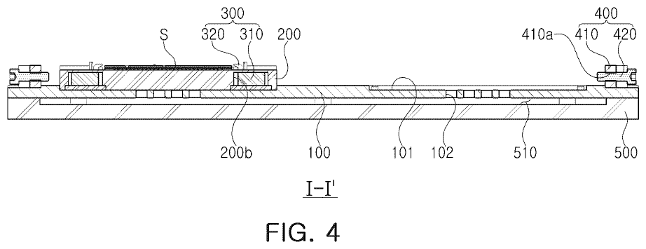

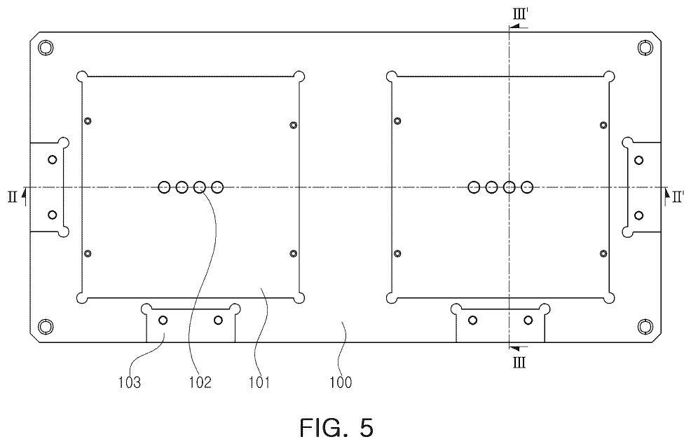

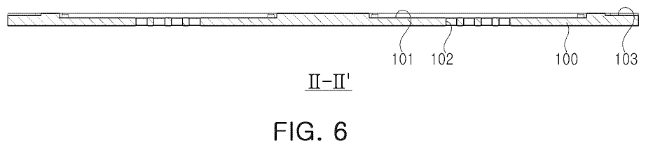

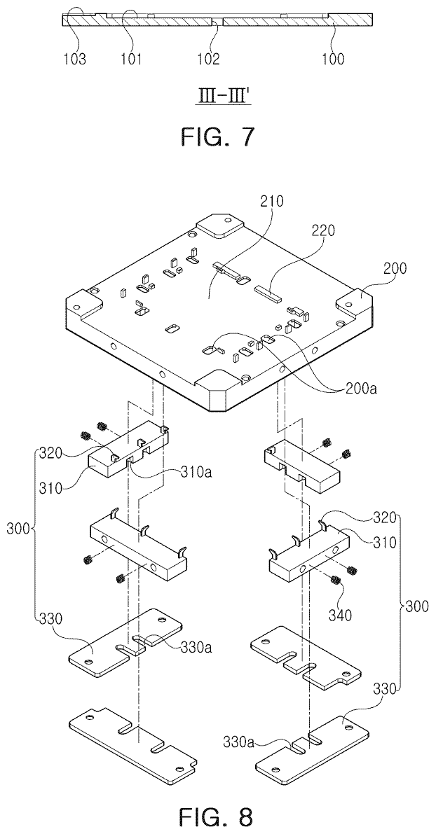

FIG. 4 is a cross-sectional view taken along line I-I′ of FIG. 1, FIG. 5 is a schematic plan view of a carrier according to an embodiment of the present disclosure, FIG. 6 is a cross-sectional view taken along line II-II′ of FIG. 5, and FIG. 7 is a cross-sectional view taken along line III-III′ of FIG. 5.

Referring to FIGS. 4 to 7, the substrate fixing jig 200 may be fixed to the carrier 100. The substrate fixing jig insertion recess 101 may be provided on one surface of the carrier 100. For example, the substrate fixing jig insertion recess 101 may be formed by depressing one surface of the carrier 100 by a predetermined depth. It is also possible to provide a plurality of substrate fixing jig insertion recesses 101 on one surface of the carrier 100. The substrate fixing jig 200 may be inserted into and fixed in the substrate fixing jig insertion recess 101. For example, at least a portion of a lower portion of the substrate fixing jig 200 may be inserted into the substrate fixing jig insertion recess 101. The substrate fixing jig insertion recess 101 may be provided to correspond to the shape of the substrate fixing jig 200. For example, when an outer shape of the substrate fixing jig 200 is provided as a square, the substrate fixing jig insertion recess 101 may be provided as a square recess. In this case, horizontal and vertical lengths of the substrate fixing jig insertion recess 101 may be provided to be greater by a predetermined length than horizontal and vertical lengths of the substrate fixing jig 200, respectively. That is, the substrate fixing jig insertion recess 101 may be provided considering the tolerance. However, the horizontal and vertical lengths of the substrate fixing jig insertion recess 101 may be equal to or less than the horizontal and vertical lengths of the substrate fixing jig 200 so that the substrate fixing jig 200 may be press-fitted into the substrate fixing jig insertion recess 101.

At least one vacuum hole 102 may be provided in the substrate fixing jig insertion recess 101. The substrate fixing jig 200 may be fixed by vacuum absorption to the substrate fixing jig insertion recess 101 through the vacuum hole 102. The carrier 100 may be detachably coupled to the heat plate 500. The heat plate 500 may include a vacuum path 510. For example, the vacuum path 510 may be depressed from one surface of the heat plate 500 by a predetermined depth. The vacuum path 510 may be connected to an external driving source. The external driving source may be, for example, a vacuum pump (not shown). When the substrate fixing jig 200 is mounted in the substrate fixing jig insertion recess 101, the vacuum hole 102 may communicate with the vacuum path 510. When the vacuum pump is driven, air inside the vacuum hole 102 and the vacuum path 510 may be sucked in, and the substrate fixing jig 200 may be vacuum-adsorbed to the substrate fixing jig insertion recess 101.

At least one jig fixing unit 400 may be provided on one surface of the carrier 100. The jig fixing unit 400 may be coupled to a jig fixing unit coupling portion 103 of the carrier 100. The jig fixing unit coupling portion 103 may be provided along an outer edge of the substrate fixing jig insertion recess 101. As an example, the jig fixing unit coupling portion 103 may be formed by depressing one surface of the carrier 100 by a predetermined depth.

The jig fixing unit 400 may press and fix a side surface of the substrate fixing jig 200. The jig fixing unit 400 may be provided in plural, and the plurality of jig fixing units 400 may press the side surface of the substrate fixing jig 200 in crossed directions. For example, the jig fixing unit 400 may include a jig fixing unit 400 capable of pressing the substrate fixing jig 200 in a length direction (an X-axis direction in FIG. 1) and a jig fixing unit 400 capable of pressing the substrate fixing jig 200 in a width direction (a Y-axis direction in FIG. 1). The number and position of the jig fixing units 400 may be variously changed according to design needs.

The jig fixing unit 400 may include, for example, a block 410 and a pressing bolt 420. The block 410 may be fixed to one surface of the carrier 100. For example, the block 410 may be mounted on and fixed to the jig fixing unit coupling portion 103. A screw hole 410a may be provided in the block 410. The pressing bolt 420 may be screw-coupled to the screw hole 410a. The pressing bolt 420 may be screw-coupled to the screw hole 410a and rotate to press the side surface of the substrate fixing jig 200 or be separated from the side surface of the substrate fixing jig 200.

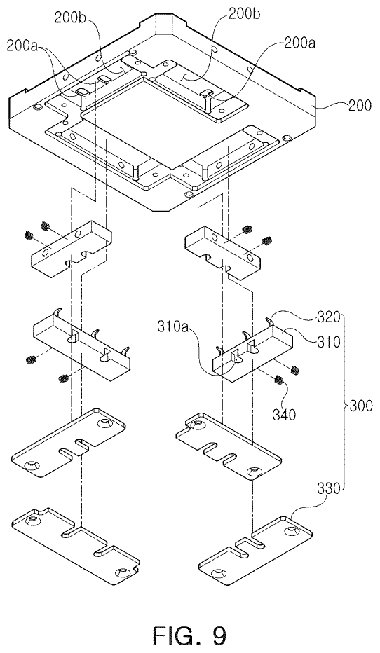

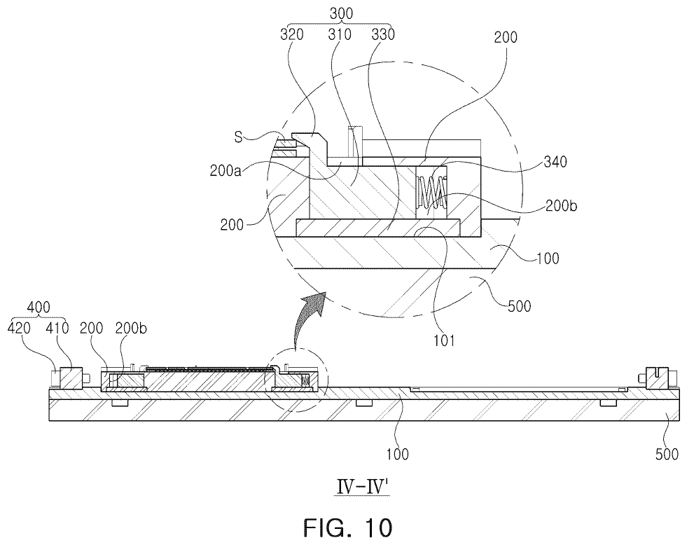

FIG. 8 is a schematic exploded top perspective view of the substrate fixing jig and the substrate support portion according to an embodiment of the present disclosure, FIG. 9 is a schematic exploded bottom perspective view of the substrate fixing jig and the substrate support portion according to an embodiment of the present disclosure, and FIG. 10 is a cross-sectional view taken along line IV-IV′ of FIG. 1.

Referring to FIGS. 8 to 10, the substrate fixing jig 200 may be provided to fix the substrate S. The substrate fixing jig 200 may be removably inserted into the substrate fixing jig insertion recess 101 of the carrier 100. The substrate fixing jig 200 may be vacuum-adsorbed into the substrate fixing jig insertion recess 10. The side surface of the substrate fixing jig 200 may be pressed by the jig fixing unit 400. The jig fixing unit 400 may press the substrate fixing jig 200 in the length direction and the width direction. The opposite side of the surface of the substrate fixing jig 200 that the jig fixing unit 400 contacts may have a lower portion caught in the substrate fixing jig insertion recess 101. Therefore, when the jig fixing unit 400 presses one surface of the substrate fixing jig 200 in the length direction and one surface of the substrate fixing jig 200 in the width direction, the substrate fixing jig 200 may be fixed.

The substrate fixing jig 200 may include a substrate accommodating portion 210. The substrate S may be mounted in the substrate accommodating portion 210. The substrate accommodating portion 210 may refer to, for example, a portion of an upper surface of the substrate fixing jig 200. The substrate fixing jig 200 may include at least one substrate support portion through-slit 200a. The substrate support portion through-slit 200a may be formed to penetrate the substrate fixing jig 200. Upper and lower regions of the substrate fixing jig 200 may be connected to each other through the substrate support portion through-slit 200a. The substrate support portion through-slit 200a may be provided along the edge of the substrate accommodating portion 210.

The substrate fixing jig 200 may include a substrate support portion accommodating recess 200b on a bottom surface. The substrate support portion accommodating recess 200b may be formed by depressing a portion of the bottom surface of the substrate fixing jig 200 upwardly. At least a portion of the substrate support portion 300 may be disposed to be slidable in the substrate support portion accommodating recess 200b. The substrate support portion accommodating recess 200b may include an elastic member 340 applying elastic force to the substrate support portion 300. The substrate support portion through-slit 200a may be provided to communicate with the substrate support portion accommodating recess 200b. A portion of the substrate support portion 300 may be disposed in the substrate support portion accommodating recess 200b, and a portion of the remainder may be disposed above the substrate fixing jig 200 by penetrating the substrate support portion through-slit 200a.

A substrate guide rib 220 may protrude from one surface of the substrate fixing jig 200. The substrate guide rib 220 may be provided to guide a position in which the substrate S is mounted. The substrate guide rib 220 may be provided along the edge of the substrate receiving recess 210, for example.

The substrate support portion 300 may be provided to fix the substrate S that is mounted on the substrate fixing jig 200. The substrate support portion 300 may be provided to be slidably moved on the substrate fixing jig 200. The substrate support portion 300 may press the upper surface of the substrate S to tightly fix the substrate S to the substrate fixing jig 200. At least a portion of the substrate support portion 300 may be disposed in the substrate support portion accommodating recess 200b, and at least a portion of the remainder of the substrate support portion 300 may be exposed upwardly of the substrate fixing jig 200 by penetrating the substrate support portion through-slit 200a. The substrate support portion 300 may include, for example, a body part 310, a clamp part 320, and a cover part 330.

The body part 310 may be slidably inserted into the substrate support portion accommodating recess 200b. An elastic member 340 applying elastic force in an inward direction of the substrate fixing jig 200 to the body part 310 may be provided between the body part 310 and the substrate support portion accommodating recess 200b. The elastic member 340 may be provided as a spring, for example. The body part 310 may include an opening/closing bar insertion recess 310a.

The clamp part 320 may protrude from one surface of the body part 310. For example, the clamp part 320 may protrude from the upper surface of the body part 310. The clamp part 320 may penetrate the substrate fixing jig 200 so that one side thereof may be exposed upwardly of the substrate fixing jig 200. For example, the clamp part 320 may be exposed upwardly of the substrate fixing jig 200 through the substrate support portion through-slit 200a.

One side of the clamp part 320 exposed upwardly of the substrate fixing jig 200 may be bent in a direction toward the substrate accommodating portion 210 to hold the substrate accommodating portion in place. The bent end portion of the clamp part 320 may be disposed above the substrate accommodating portion 210 or moved to the outside of the substrate accommodating portion 210 as the substrate support portion 300 slides. When the bent end portion of the clamp part 320 is disposed above the substrate accommodating portion 210, the clamp part 320 may fix the substrate S.

The cover part 330 may be coupled to the substrate fixing jig 200. The cover part 330 may be provided to be coupled to a bottom surface of the substrate fixing jig 200 and cover at least a portion of the bottom surface of the body part 310. The cover part 330 may include an exposure recess 330a. The exposure recess 330a may be formed by depressing a portion of a side surface of the cover part 330 by a predetermined depth. A depressed length of the exposure recess 330a may be greater than a depressed length of the opening/closing bar insertion recess 310a of the body part 310. Therefore, the opening/closing bar insertion recess 310a and a portion of the bottom surface of the body part 310 may be exposed to the outside of the substrate fixing jig 200 through the exposure recess 330a.

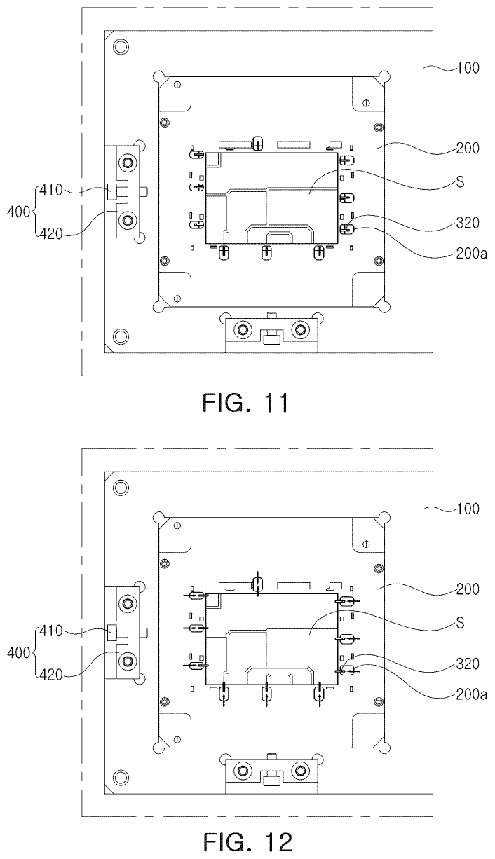

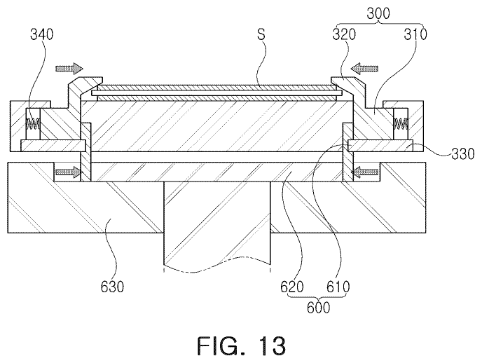

FIG. 11 is a plan view illustrating a state in which a substrate support portion is slidably moved in a substrate fixing jig so that a substrate may be coupled and separated, FIG. 12 is a plan view illustrating a state in which a substrate is fixed in a substrate fixing jig, and FIG. 13 is a cross-sectional view illustrating an operation of a substrate support portion according to an embodiment of the present disclosure.

Referring to FIGS. 11 to 13, a process of fixing the substrate S to the substrate fixing jig 200 will be described. The substrate S may be fixed to the substrate fixing jig 200. The substrate S may be fixed to the substrate fixing jig 200 before the substrate fixing jig 200 is inserted into the substrate fixing jig insertion recess 101 of the carrier 100. In order to fix the substrate S to the substrate fixing jig 200, the substrate fixing jig 200 may be coupled to an opening/closing module 600.

The opening/closing module 600 may press and slide the substrate support portion 300. Depending on the position in which the substrate support portion 300 slides, the substrate S may be fixed to the substrate accommodating portion 210 (see FIG. 12) or separated from the substrate accommodating portion 210 (see FIG. 11). For example, when the opening/closing module 600 slides the substrate support portion 300 toward the outside of the substrate accommodating portion 210 so that the clamp part 320 moves toward the outside of the substrate accommodating portion 210, the substrate S may be mounted in the substrate accommodating portion 210 or separated from the substrate accommodating portion 210, and when the clamp part 320 slides toward the inside of the substrate accommodating portion 210 so that at least a portion of the clamp part contacts the substrate S, the substrate S may be fixed.

The opening/closing module 600 may include, for example, an opening/closing bar 610, a cam member 620, and a housing 630. When the substrate fixing jig 200 is coupled to the opening/closing module 600, the opening/closing bar 610 may penetrate the exposure recess 330a and be inserted into the opening/closing bar insertion recess 310a. The cam member 620 may rotate to move the opening/closing bar 610 to the outside or inside of the substrate accommodating portion 210. The cam member 620 may be provided in a shape in which a horizontal diameter thereof increases or decreases based on FIG. 13 as the cam member 620 rotates.

When the cam member 620 rotates to move the opening/closing bar 610 in an outward direction of the substrate accommodating portion 210, the opening/closing bar 610 may press the body part 310 of the substrate support portion 300 outwardly, thereby moving the clamp part 320 outwardly of the substrate accommodating portion 210. When the cam member 620 rotates again and the diameter thereof decreases, the elastic member 340 may press the body part 310 of the substrate support portion 300 to move the clamp part 320 inwardly of the substrate accommodating portion 210.

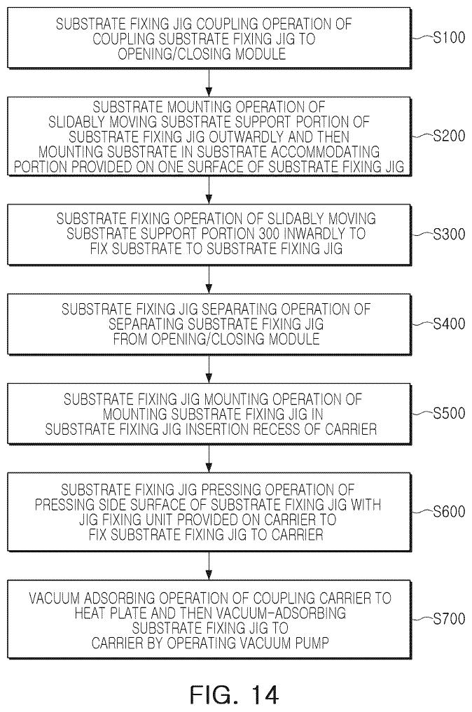

FIG. 14 is a schematic flowchart of a substrate fixing method according to another embodiment of the present disclosure.

Referring to FIG. 14, the substrate fixing method may include a substrate fixing jig coupling operation (S100), the substrate mounting operation (S200), a substrate fixing operation (S300), a substrate fixing jig separating operation (S400), a substrate fixing jig mounting operation (S500), a substrate fixing jig pressing operation (S600), and a vacuum adsorbing operation (S700).

In the substrate fixing jig coupling operation (S100), the substrate fixing jig 200 may be coupled to the opening/closing module 600. When the substrate fixing jig 200 is coupled to the opening/closing module 600, the opening/closing bar 610 of the opening/closing module 600 may be inserted into the opening/closing bar insertion recess 310a of the substrate support portion 300.

When the substrate fixing jig coupling operation (S100) is completed, the substrate mounting operation (S200) may be performed. In the substrate mounting operation (S200), the substrate support portion 300 may be slidably moved outwardly by rotating the cam member 620 of the opening/closing module 600. The substrate support portion 300 may slide until the clamp part 320 moves outwardly of the substrate accommodating portion 210. When the clamp part 320 moves outwardly of the substrate accommodating portion 210, the substrate S may be mounted in the substrate accommodating portion 210.

When the substrate S is mounted in the substrate accommodating portion 210, the substrate fixing operation (S300) may be performed. In the substrate fixing operation (S300), the substrate support portion 300 may slide inwardly of the substrate accommodating portion 210. As the substrate support portion 300 moves inwardly of the substrate accommodating portion 210, the clamp part 320 of the substrate support portion 300 may contact the substrate S to tightly fix the substrate S to the substrate accommodating portion 210.

After the substrate fixing operation (S300), the substrate fixing jig separating operation (S400) may be performed. In the substrate fixing jig separating operation (S400), the substrate fixing jig 200 may be separated from the opening/closing module 600. Thereafter, the substrate fixing jig mounting operation (S500) may be performed. In the substrate fixing jig mounting operation (S500), the substrate fixing jig 200 may be mounted in the substrate fixing jig insertion recess 101 of the carrier 100. When the substrate fixing jig 200 is mounted in the substrate fixing jig insertion recess 101, the substrate fixing jig pressing operation (S600) may be performed. The substrate fixing jig pressing operation (S600) may be an operation of pressing a side surface of the substrate fixing jig 200 with the jig fixing unit 400 provided on the carrier 100 to fix the substrate fixing jig 200 to the carrier 100. The vacuum adsorbing operation (S700) may be performed after the substrate fixing jig pressing operation (S600). In the vacuum adsorbing operation (S700), the carrier 100 may be coupled to the heat plate 500. When the carrier 100 is coupled to the heat plate 500, a vacuum pump may be operated. When the vacuum pump is operated, the air in the vacuum path 510 of the heat plate 500 and the vacuum hole 102 of the carrier 100 may be removed, and accordingly, the substrate fixing jig 200 may be vacuum-adsorbed to the carrier 100.

The substrate fixing jig assembly and the substrate fixing method using the same according to embodiments of the present disclosure may minimize the bending deformation of the substrate during the sintering process.

The substrate fixing jig assembly and the substrate fixing method using the same according to embodiments of the present disclosure may maintain the substrate in the correct position during the sintering process.

While embodiments have been shown and described above, it will be apparent to those skilled in the art that modifications and variations could be made without departing from the scope of the present disclosure as defined by the appended claims.

1. A substrate fixing jig assembly comprising:
a carrier having a substrate fixing jig insertion recess;
a substrate fixing jig being removably inserted into the substrate fixing jig insertion recess, and having a substrate accommodating portion; and
a substrate support portion slidably provided on the substrate fixing jig, and configured to fix a substrate accommodated in the substrate accommodating portion.

2. The substrate fixing jig assembly of claim 1, wherein the substrate support portion is configured to slide within a substrate support portion accommodating recess positioned on a bottom surface of the substrate fixing jig.

3. The substrate fixing jig assembly of claim 2, wherein the substrate fixing jig includes at least one substrate support portion through-slit positioned along an edge of the substrate accommodating portion, and the substrate support portion through-slit is configured to communicate with the substrate support portion accommodating recess.

4. The substrate fixing jig assembly of claim 3, wherein at least a first portion of the substrate support portion is positioned in the substrate support portion accommodating recess, and at least a second portion of the substrate support portion is exposed upwardly of the substrate fixing jig through the substrate support portion through-slit.

5. The substrate fixing jig assembly of claim 2, wherein the substrate support portion includes:
a body part slidably inserted into the substrate support portion accommodating recess;
a clamp part protruding from the body part and having one side exposed upwardly of the substrate fixing jig through the substrate fixing jig; and
a cover part coupled to the substrate fixing jig configured to cover at least a portion of a bottom surface of the body part.

6. The substrate fixing jig assembly of claim 5, wherein a first side of the clamp part is bent in a direction toward the substrate accommodating portion, and the bent clamp part is disposed above the substrate accommodating portion or is configured to move outwardly from the substrate accommodating portion as the substrate support portion slides.

7. The substrate fixing jig assembly of claim 5, wherein the body part includes an opening and closing bar insertion recess, and the cover part includes an exposure recess exposing the opening and closing bar insertion recess outwardly from the substrate fixing jig.

8. The substrate fixing jig assembly of claim 7, further comprising an opening and closing module configured to press the body part to slidably move the substrate support portion.

9. The substrate fixing jig assembly of claim 8, wherein the opening and closing module includes:
an opening and closing bar inserted into the opening and closing bar insertion recess through the exposure recess; and
a cam member mechanically connected to the opening and closing bar, and configured to rotate to slidably move the opening and closing bar.

10. The substrate fixing jig assembly of claim 5, wherein the substrate support portion accommodating recess includes an elastic member configured to apply elastic force to the body part.

11. The substrate fixing jig assembly of claim 1, wherein the carrier includes a jig fixing unit configured to press a side surface of the substrate fixing jig.

12. The substrate fixing jig assembly of claim 11, wherein the jig fixing unit includes:
a first jig fixing unit configured to press the substrate fixing jig in a length direction; and
a second jig fixing unit configured to press the substrate fixing jig in a width direction.

13. The substrate fixing jig assembly of claim 11, wherein the jig fixing unit includes:
a block fixed to a surface of the carrier and having a screw hole; and
a pressure bolt screwed to the screw hole, and configured to rotate to press the side surface of the substrate fixing jig, or to be separated from the side surface of the substrate fixing jig.

14. The substrate fixing jig assembly of claim 1, wherein a substrate guide rib protrudes from a surface of the substrate fixing jig.

15. The substrate fixing jig assembly of claim 14, wherein the substrate guide rib is positioned along an edge of the substrate accommodating portion.

16. The substrate fixing jig assembly of claim 1, further comprising a heat plate configured to heat the carrier, wherein the carrier is detachably coupled to the heat plate.

17. The substrate fixing jig assembly of claim 16, wherein the heat plate includes a vacuum path, and the substrate fixing jig insertion recess includes a vacuum hole communicating with the vacuum path.

18. A substrate fixing method comprising:
coupling a substrate fixing jig to an opening and closing module;
sliding a substrate support portion of the substrate fixing jig, and then mounting a substrate in a substrate accommodating portion provided on one surface of the substrate fixing jig;
slidably moving the substrate support portion to fix the substrate to the substrate fixing jig;
separating the substrate fixing jig from the opening and closing module;
mounting the substrate fixing jig in a substrate fixing jig insertion recess of a carrier; and
pressing a side surface of the substrate fixing jig with a jig fixing unit provided on the carrier to fix the substrate fixing jig to the carrier.

19. The substrate fixing method of claim 18, further comprising fixing the carrier to a heat plate provided with a vacuum path.

20. The substrate fixing method of claim 19, further comprising adsorbing the substrate fixing jig to the carrier by driving a vacuum pump connected to the heat plate.
